(19) United States
(12) Patent Application Publication
(10) Pub. No.: US 2011/0006223 A1
(43) Pub. Date: Jan. 13, 2011

(54) RADIATION SOURCE ASSEMBLY AND FLUID TREATMENT SYSTEM

(75) Inventors: Li-Zheng Ma, London (CA); George Traubenberg, London (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: TROJAN TECHNOLOGIES, LONDON (GB)

(21) Appl. No.: 12/808,092

(22) PCT Filed: Dec. 12, 2008
(86) PCT No.: PCT/CA08/02213

§ 371 Date: Sep. 13, 2010

Related U.S. Application Data
(60) Provisional application No. 61/006,035, filed on Dec. 14, 2007.

(51) Int. Cl. G21K 5/00; G21K 1/00

(52) U.S. Cl. 250/492.1; 250/504 R; 250/493.1

(57) ABSTRACT

There is disclosed a radiation source assembly comprising an elongate radiation emitting outer portion having non-circular cross-sectional shape and an elongate radiation source. A radiation source module and a fluid system incorporating the radiation source assembly are also disclosed. It has been discovered that the use of a non-circular shaped sleeve or outer lamp surface reduces the stress placed on these elements in a fluid treatment system in which the radiation source assemblies are disposed transverse (e.g., orthogonal) to the direction of fluid flow through the fluid treatment zone of the system.

### CROSS-REFERENCE TO RELATED APPLICATION

The present application claims the benefit under 35 U.S.C. §119(e) of provisional patent application Ser. No. 61/006,035, filed Dec. 14, 2007, the contents of which are hereby incorporated by reference.

### BACKGROUND OF THE INVENTION

1. Field of the Invention

In one of its aspects, the present invention relates to a radiation source assembly, more particularly an ultraviolet radiation source assembly. In another of its aspects, the present invention relates to a fluid treatment system, more particularly, an ultraviolet radiation water treatment system.

2. Description of the Prior Art

Fluid treatment systems are generally known in the art. More particularly, ultraviolet (UV) radiation fluid treatment systems are generally known in the art.

Early treatment systems comprised a fully enclosed chamber design containing one or more radiation (preferably UV) lamps. Certain problems existed with these earlier designs. These problems were manifested particularly when applied to large open flow treatment systems which are typical of larger scale municipal waste water or potable water treatment plants. Thus, these types of reactors had associated with them the following problems:
relatively high capital cost of reactor;
difficult accessibility to submerged reactor and/or wetted equipment (lamps, sleeve cleaners, etc);
difficulties associated with removal of fouling materials from fluid treatment equipment;
relatively low fluid disinfection efficiency, and/or
full redundancy of equipment was required for maintenance of wetted components (sleeves, lamps and the like).

The shortcomings in conventional closed reactors led to the development of the so-called “open channel” fluid treatment systems.

For example, U.S. Pat. Nos. 4,482,809, 4,872,980 and 5,006,244 (all in the name of Maarschalkerweerd and all assigned to the assignee of the present invention and hereinafter referred to as the Maarschalkerweerd #1 patents) all describe gravity fed fluid treatment systems which employ ultraviolet (UV) radiation.

Such systems included an array of UV lamp modules (e.g., frames) which included several UV lamps each of which are mounted within sleeves which extend between and are supported by a pair of legs which are attached to a cross-piece. Typically, the lamps were relatively low power and range from 3 ft. to 5 ft. in length. The so-supported sleeves (containing the UV lamps) are immersed into a fluid to be treated which is then irradiated as required. The amount of radiation to which the fluid is exposed is determined by the proximity of the fluid to the lamps, the output wattage of the lamps and the flow rate of the fluid past the lamps. Typically, one or more UV sensors may be employed to monitor the UV output of the lamps and the fluid level is typically controlled, to some extent, downstream of the treatment device by means of level gates or the like.

The fluid treatment system taught in the Maarschalkerweerd #1 patents is characterized by having a free-surface flow of fluid (typically the top fluid surface was not purposely controlled or constrained). Thus, the systems would typically follow the behaviour of open channel hydraulics. Since the design of the system inherently comprised a free-surface flow of fluid, there were constraints on the maximum flow each lamp or lamp array could handle before either one or other hydraulically adjoined arrays would be adversely affected by changes in water elevation. At higher flows or significant changes in the flow, the unrestrained or free-surface flow of fluid would be allowed to change the treatment volume and cross-sectional shape of the fluid flow, thereby rendering the reactor relatively ineffective. Provided that the power to each lamp in the array was relatively low, the subsequent fluid flow per lamp would be relatively low. The concept of a fully open channel fluid treatment system would suffice in these lower lamp power and subsequently lower hydraulically loaded treatment systems. The problem here was that, with less powerful lamps, a relatively large number of lamps was required to treat the same volume of fluid flow. Thus, the inherent cost of the system would be unduly large and/or not competitive with the additional features of automatic lamp sleeve cleaning and large fluid volume treatment systems.

This led to the so-called “semi-enclosed” fluid treatment systems.

U.S. Pat. Nos. 5,418,370, 5,539,210 and Re36,896 (all in the name of Maarschalkerweerd and all assigned to the assignee of the present invention and hereinafter referred to as the Maarschalkerweerd #2 patents) all describe an improved radiation source module for use in gravity fed fluid treatment systems which employ UV radiation. Generally, the improved radiation source module comprises a radiation source assembly (typically comprising a radiation source and a protective (e.g., quartz) sleeve) sealingly cantilevered from a support member. The support member may further comprise appropriate means to secure the radiation source module in the gravity fed fluid treatment system.

Thus, in order to address the problem of having a large number of lamps and the incremental high cost of cleaning associated with each lamp, higher output lamps were applied for UV fluid treatment. The result was that the number of lamps and subsequent length of each lamp was dramatically reduced compared with the “open channel” fluid treatment systems described above. This led to commercial affordability of automatic lamp sleeve cleaning equipment, reduced space requirements for the treatment system and other benefits. In order to use the more powerful lamps (e.g., medium pressure UV lamps), the hydraulic loading per lamp during use of the system would be increased to an extent that the treatment volume/cross-sectional area of the fluid in the reactor would significantly change if the reactor surface was not confined on all surfaces, and hence such a system would be rendered relatively ineffective. Thus, the Maarschalkerweerd #2 patents are characterized by having a closed surface confining the fluid being treated in the treatment area of the reactor. This closed treatment system had open ends which, in effect, were disposed in an open channel. The submerged or wetted equipment (UV lamps, cleaners and the like) could be extracted using pivoted hinges, sliders and various other devices allowing removal of equipment from the semi-enclosed reactor to the free surfaces.

The fluid treatment system described in the Maarschalkerweerd #2 patents was typically characterized by relatively short length lamps which were cantilevered to a substantially vertical support arm (i.e., the lamps were supported at one end only). This allowed for pivoting or other extraction of the lamp from the semi-enclosed reactor. These significantly shorter and more powerful lamps inherently are characterized by being less efficient in converting electrical energy to UV energy. The cost associated with the equipment necessary to physically access and support these lamps was significant.

So-called “closed” fluid treatment systems are known—see, for example, U.S. Pat. No. 5,504,335 (Maarschalkerweerd #3) and U.S. Pat. No. 6,500,346 [Taghipour et al. (Taghipour)]. Generally, these systems are characterized by placement of UV radiation sources in a pressurized fluid chamber (e.g., a pipe). The fluid treatment zone confines the fluid on all sides/surfaces.

Practical implementation of known fluid treatment systems of the type described above has been based on using radiation sources that have a circular cross-section (or placement of such a source in a quartz sleeve having a circular cross-section) wherein the longitudinal axis of the radiation source is: (i) parallel to the direction of fluid flow through the fluid treatment system, or (ii) orthogonal to the direction of fluid flow through the fluid treatment system. Further, in arrangement (ii), it has been common to place the lamps in an array such that, from an upstream end to a downstream end of the fluid treatment system, a downstream radiation source is placed directly behind an upstream radiation source.

Unfortunately, for the treatment of large volumes of fluid, arrangement (ii) can be disadvantageous for a number of reasons.

First, the use of a large number of radiation sources in arrangement (ii) creates a relatively large drag force resulting in a relatively large hydraulic pressure loss/gradient over the length of the fluid treatment system—this is also a problem with arrangement (i). For each of arrangement (i) and arrangement (ii), there is an increase in hydraulic resistance as the flow rate is increased through the fluid treatment system. As a function of increased lamp power, this hydraulic resistance eventually limits the commercial application of arrangement (i) in UV fluid treatment systems, even when used in the to above-mentioned “semi-enclosed” and “closed” fluid treatment systems. Practically, there is a limit to the available fluid level change (available headloss) at most municipal wastewater or drinking water treatment plants. For example, typically existing municipal wastewater treatment plants can tolerate a fluid level change between 1 to 3 feet. Thus, adding further elements to the fluid treatment system that result in an increase in hydraulic resistance could exceed this tolerance.

Second, the use of radiation sources in arrangement (ii) creates a pressure differential between the upstream and downstream regions adjacent each radiation source. This leads to an increase in stress to which the radiation source is subject resulting in an increase likelihood of breakage of the radiation source.

Third, the use of a large number of radiation sources in arrangement (ii) can produce vortex effects (these effects are discussed in more detail hereinbelow) resulting in forced oscillation of the radiation sources—such forced oscillation increases the likelihood of breakage of the radiation source and/or protective sleeve (if present).

As a result of recent developments in UV lamp technology, UV radiation sources that are relatively longer, more powerful and have high efficiency are available. However, limits in the design of the convention fluid treatment systems (reactors) restrict the full performance and cost saving potential from using these relatively new powerful and long lamps. These powerful UV lamps that are also energy efficient would reduce the direct material/manufacturing cost (DMC) of UV fluid treatment systems and make the UV fluid treatment systems simpler and easier to maintain, while also providing lower operating costs. This is possible since, when using more powerful UV lamps, such UV lamps would be required to achieve a prescribed radiation output level.

The use of more powerful UV lamps is currently restricted since the “open channel” fluid treatment systems described above are not suitable when using these lamps. This is because the free surface within the disinfection zone becomes unmanageable due to the higher hydraulic loading (increased flow rate) that is required to take advantage of the more powerful UV lamps. Early studies have shown that “open channel” fluid treatment systems described above are restricted to a lower range of lamp power. In addition, use of these lamps in a cross-flow arrangement leads to the creation of pressure differentials described above and the consequential increased likelihood of lamp breakage.

Accordingly, there remains a need in the art for a radiation source assembly for use in a fluid treatment system that will obviate and/or mitigate at least one of the above-mentioned disadvantages of the prior art.

### SUMMARY OF THE INVENTION

It is an object of the present invention to provide a novel fluid treatment system which obviates or mitigates at least one of the above-mentioned disadvantages of the prior art.

Accordingly, in one of its aspects, the present invention relates to a radiation source assembly comprising an elongate radiation emitting outer portion having non-circular cross-sectional shape and an elongate radiation source.

In another of its aspects, the present invention relates to a fluid treatment system comprising at least one such radiation source assembly.

In yet another of its aspects, the present invention relates to radiation source module comprising at least one such radiation source assembly.

In yet another of its aspects, the present invention relates to a fluid treatment system comprising at least one such radiation source module.

As used throughout this specification, the term “fluid” is intended to have a broad meaning and encompasses liquids and gases. The preferred fluid for treatment with the present system is a liquid, preferably water (e.g., wastewater, industrial effluent, reuse water, potable water, ground water and the like).

Those with skill in the art will recognize that implementation of the present invention typically will involve the use of seals and the like to provide a practical fluid seal between adjacent elements in the fluid treatment system. For example, those of skill in the art will recognize that it is well known in the art to use combinations of coupling nuts, O-rings, bushings and like to provide a substantially fluid tight seal between the exterior of a radiation source assembly (e.g., water) and the interior of a radiation source assembly containing the radiation source (e.g., an ultraviolet radiation lamp). Details on the use of seals and the like may be obtained, for example, from the prior art references referred to above.

### BRIEF DESCRIPTION OF THE DRAWINGS

Embodiments of the present invention will be described with reference to the accompanying drawings, wherein like numerals designate like elements, and in which:

FIG. 1 illustrates the flow path of the fluid and vortex lines in a cross-flow (CF) reactor having circular sleeves (as shown, fluid flow separations occur further upstream with respect to the surface of the circular sleeve);

FIG. 2 illustrates the fluid and vortex lines in a CF reactor having elliptical sleeves (as shown, fluid flow separations occur further downstream with respect to the surface of the elliptical sleeve);

FIG. 3 illustrates a comparison of system stresses and hydraulic loss for the elliptical sleeves at various numbers of rows (hydraulic head loss is about ½ and the bending stress about ¼ in a CF reactor having elliptical sleeves when compared to a CF reactor having circular sleeves);

FIG. 4 illustrates a comparison of system disinfection performance (efficiency) and hydraulic loss at various numbers of lamp rows for an elliptical sleeve reactor versus a circular sleeve reactor (the number of rows one could use with a CF reactor with the elliptical sleeves would be about 75% more and the disinfection efficiency would be about 25% higher (e.g., at 14 rows) when compared to a CF reactor with circular sleeves having only 8 rows);

FIG. 5a illustrates and example of a CF reactor with a circular sleeve;

FIG. 5b illustrates an example of a CF reactor with elliptical sleeves;

FIG. 6 illustrates an enlarged sectional view of an embodiment of the present radiation source assembly comprising a UV lamp disposed in an elliptical sleeve;

FIG. 7 illustrates an enlarged sectional view of an embodiment of the present radiation source assembly comprising a UV lamp disposed in an elliptical sleeve having a variable thicknesses in the sleeve wall;

FIG. 8 illustrates an enlarged sectional view of an embodiment of the present radiation source assembly comprising a pair of UV lamps disposed in an elliptical sleeve (the UV lamps are equidistant from the center of the sleeve);

FIG. 9 illustrates an enlarged sectional view of an embodiment of the present radiation source assembly comprising a pair of UV lamps disposed in an elliptical sleeve (the UV lamps are equidistant from the center of the sleeve) having a UV reflector interposed between the UV lamps;

FIG. 10a illustrates a cross-section of a first preferred configuration of the outer surface of the present radiation source assembly, including an indication of the minor axis and the major axis, together with a definition of the aspect ratio (i.e., ratio of major axis to minor axis);

FIG. 10b illustrates a cross-section of a second preferred configuration of the outer surface of the present radiation source assembly, including an indication of the major axis; and

FIG. 11 illustrates the relationship between stress (normalized) and aspect ratio (i.e., ratio of major axis to minor axis) of the outer surface of the present radiation source assembly.

### DETAILED DESCRIPTION OF THE PREFERRED EMBODIMENTS

The present inventors have discovered that the use of a non-circular shaped sleeve or outer lamp surface reduces the stress placed on these elements in a fluid treatment system in which the radiation source assemblies are disposed transverse (e.g., orthogonal) to the direction of fluid flow through the fluid treatment zone of the system.

Thus, an aspect of the present invention relates to a radiation source assembly comprising an elongate radiation emitting outer portion having non-circular cross-sectional shape and an elongate radiation source.

In one embodiment, the elongate radiation emitting outer portion and the elongate radiation source are integral (e.g., a DBD radiation sources such as described in International Publication Number WO 2007/071042 [Fraser et al.], International Publication Number WO 2007/071043 [Fraser et al.] and International Publication Number WO 2007/071074 [Fraser et al.].

In another embodiment, the elongate radiation emitting outer portion and the elongate radiation source are independent elements. For example, the elongate radiation emitting outer portion may comprise a radiation transparent sleeve element (e.g., made from quartz). The radiation transparent sleeve element and the elongate radiation source may be disposed in a substantially coaxial arrangement or in a non-coaxial arrangement.

It is possible to configure the present radiation source assembly such that a plurality of elongate radiation sources is disposed in a single radiation transparent sleeve element. For example, it is possible to dispose two elongate radiation sources in a single radiation transparent sleeve element. Preferably, in such an arrangement, a radiation reflecting element is interposed between a pair of elongate radiation source.

The radiation transparent sleeve element may comprise a pair of open ends. In such a case, it is preferred that the elongate radiation source comprises a first electrical connector at one end thereof and a second electrical connection at another end thereof.

Alternatively, the radiation transparent sleeve element may comprise an open end and a closed end. In such a case, it is preferred that the elongate radiation source comprises a first electrical connector and a second electrical connector at one end thereof.

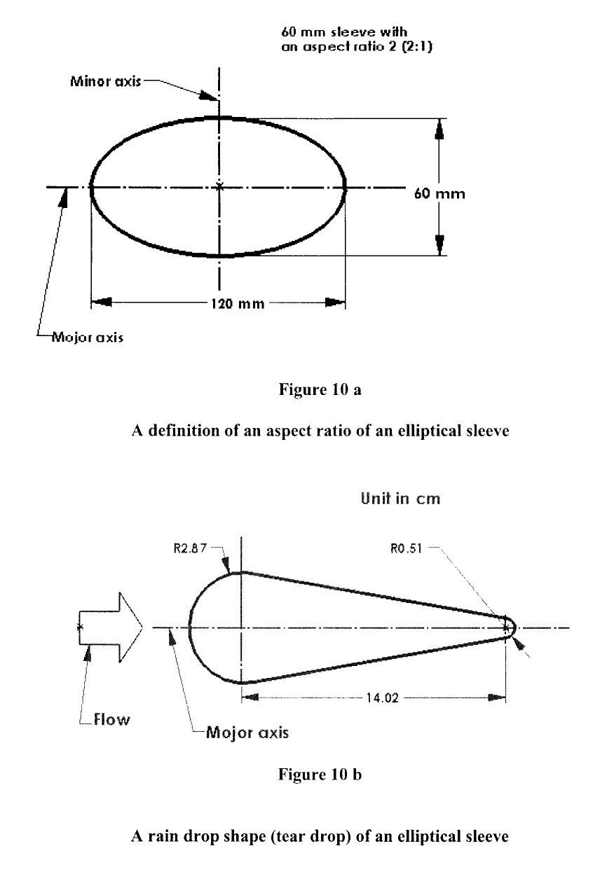

Preferably, the elongate radiation emitting outer portion has a cross-sectional shape that comprises a first dimension along a first axis (major axis) and a second dimension along a second axis (minor axis), the first dimension being greater than the second dimension. FIG. 10 illustrates a preferred cross-section shape of the elongate radiation emitting outer portion. It is preferred that the first axis is orthogonal to the second axis. It is also preferred that one or both of the first axis and the second axis is an axis of symmetry.

In one embodiment, the elongate radiation emitting outer portion comprises a substantially uniform thickness.

In another embodiment, the elongate radiation emitting outer portion comprises a variable thickness. Preferably, the variable thickness is in the form of a thickness gradient along a span of the elongate radiation emitting outer portion between the first axis intercept and the second axis intercept, (the intercept is defined as the point where the respective axis contacts the radiation emitting outer portion). More preferably, the variable thickness is in the form of a decreasing thickness gradient along at least a span of the elongate radiation emitting outer portion between the first axis and the second axis. Even more preferably, the variable thickness is in the form of a decreasing thickness gradient along each span of the elongate radiation emitting outer portion between the first axis intercept and the second axis intercept.

Preferably, the first axis is coterminous with a maximum thickness of the elongate radiation emitting outer portion. In this context, the elongate radiation emitting outer portion may comprise a pair of maximum thickness dimensions in alignment with the first axis.

The elongate radiation emitting outer portion has a non-circular cross-sectional shape. In one preferred embodiment the cross-sectional shape comprises an oval. In another preferred embodiment the cross-sectional shape comprises an obround. In another preferred embodiment, the cross-sectional shape comprises a lens. In yet another preferred embodiment, the cross-sectional shape comprises the shape of a water drop. In another, more preferred, embodiment the cross-sectional shape comprises an ellipse.

Preferably, the radiation source used in the present radiation source assembly is an ultraviolet radiation source.

While the remainder of the disclosure will refer to sleeve having an elliptical cross-section, this is for illustrative purposes only and the scope of the present invention should not be restricted to radiation source assemblies that utilize such sleeves.

Experiments and analysis studies (classic Fluid Mechanics) show that an elliptical sleeve will have very low hydraulic resistance. This hydraulic resistance may be further reduced by increasing the aspect ratio (discussed in more detail below) of its major axis dimension to its minor axis dimension, particularly in the direction of fluid flow.

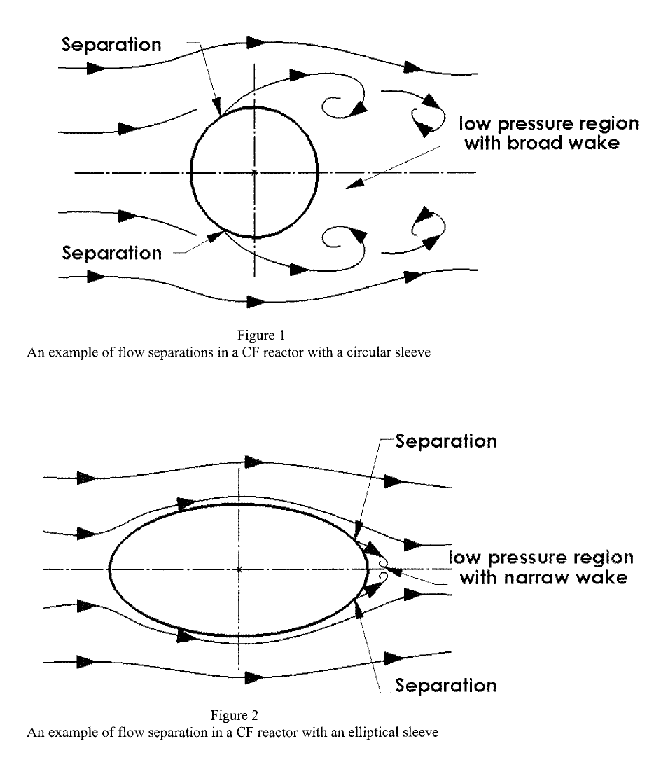

A mechanism for lower hydraulic resistance of an elliptical sleeve has been illustrated with reference to FIG. 1 and FIG. 2. Comparing the flow path along the circular sleeve (see FIG. 1) and an elliptical sleeve (see FIG. 2), it is evident that the separation points of fluid flow on the surface of the sleeve are different for a circular sleeve as compared to an elliptical sleeve. The separation points on the surface of the circular sleeve are much closer to the front of the circular sleeve. This will form a relatively large low pressure region behind the sleeve. This condition will generate a large differential dynamic pressure across the sleeve and will also produce a high hydraulic resistance to the incoming fluid flow. However, the separation points of fluid flow on the surface of an elliptical sleeve will be further downstream on the elliptical sleeve. On a relative scale, this separation region behind the elliptical sleeve is much smaller compared to the circular sleeve. The result is a higher pressure being maintained on the downstream portion of the elliptical sleeve as compared to a circular sleeve. This results in the elliptical sleeve having a smaller differential dynamic pressure than the circular sleeve. Therefore the elliptical sleeve will have low hydraulic resistance to incoming fluid flow and will therefore experience lower physical force from flow induced pressure differentials (i.e., lower flow induced stress).

In a preferred embodiment of the present fluid treatment system, the major axis of the elliptical sleeve is oriented such that its major axis is substantially parallel to the direction of fluid flow through the fluid treatment zone of the system. This orientation results in an increase in the resistance to any bending stresses by a considerable degree. An elliptical sleeve will be much harder to break in a given operating environment (e.g., fluid flow rate, number of rows or radiation source and the like) as compared to a circular sleeve.

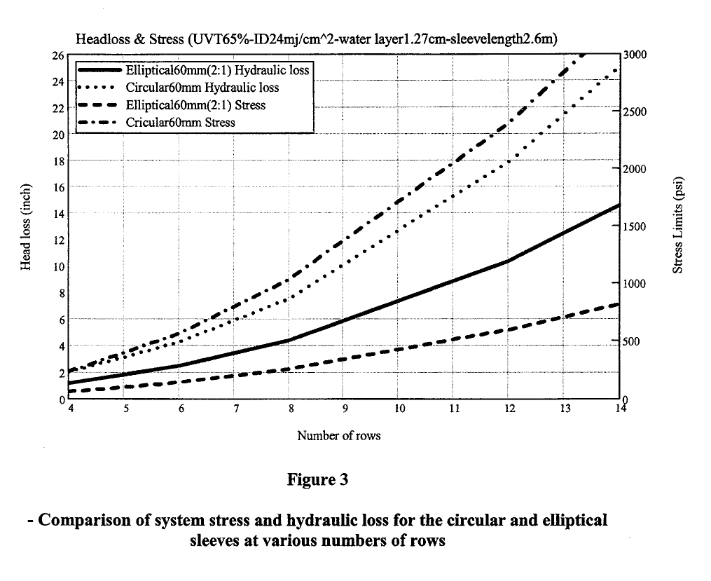

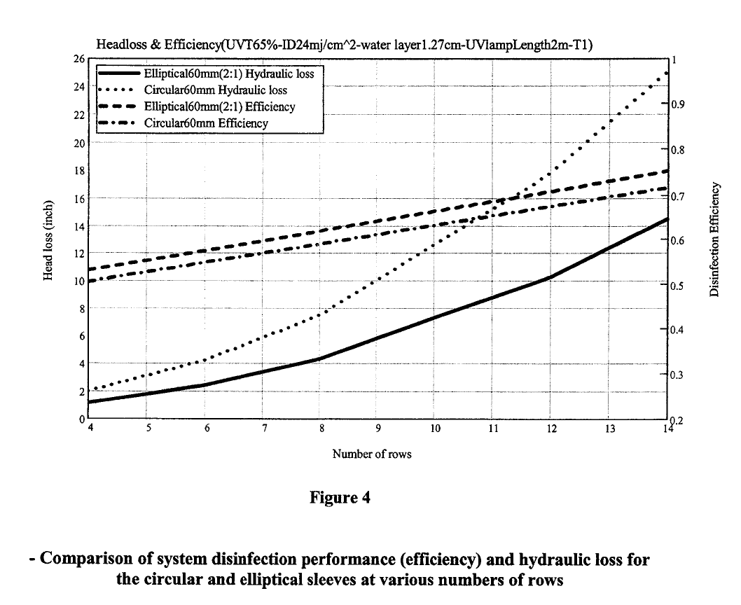

The summary results for this advantage can be found in FIGS. 3 and 4. It can be seen that at similar operational conditions, the bending stress on an elliptical sleeve would be about 4 times less than that on a circular sleeve. For example, at a stress limit of 1000 psi, a cross-flow (CF) reactor with 2.6 m length and 120 mm×60 mm-elliptical sleeves (2:1) could be operated with about 1.75 times the number of UV lamp rows in hydraulic series than that in a CF reactor with circular sleeves at the same operating condition (i.e., treated flow per lamp). It is also shown that the disinfection efficiency in a CF reactor with elliptical sleeves would be increased by about 25% due to the benefit of a larger number of rows in the system and the increased disinfection efficiency of the elliptical shaped sleeve itself.

Furthermore, a UV fluid treatment system with elliptical sleeves will have relatively higher disinfection efficiency than a UV fluid treatment system with circular sleeves. This is due to a fact that an elliptical sleeve has a much longer perimeter which will increase the possibility for fluid flow passing around the sleeve to receive more UV light. This results in a UV reactor with elliptical sleeves having higher disinfection efficiency.

In summary a UV reactor having elliptical shaped sleeves will have a greater flow capacity (low hydraulic headloss) and higher disinfection efficiency and system redundancy. An important added advantage is an increase of UV system redundancy by being able to have more UV lamps in hydraulic series. Having more UV lamps in hydraulic series allows for more options regarding UV lamps being turned off and on (more refined dose pacing and longer lamp life) and being out of channel for system maintenance as well as redundancy in case of equipment or lamp malfunction.

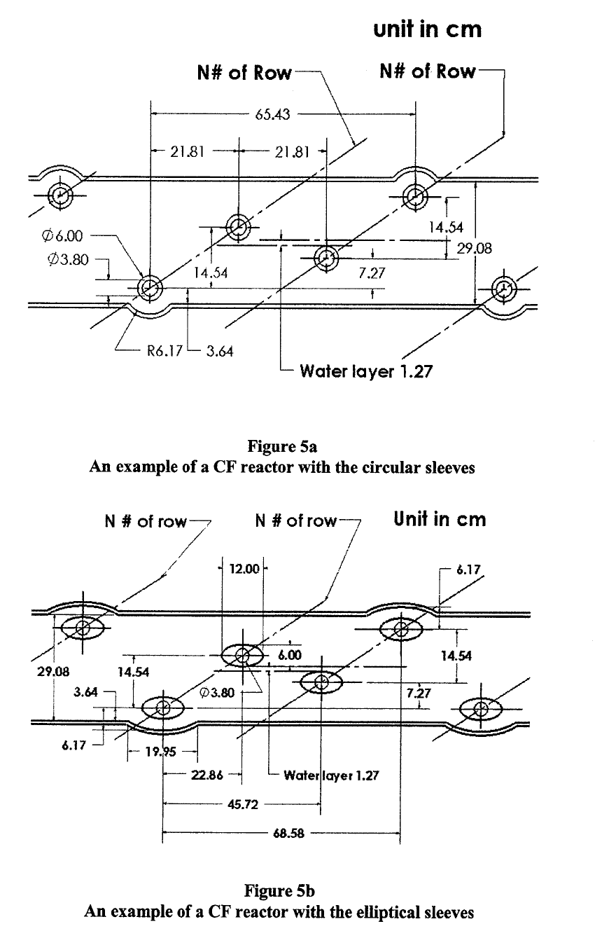

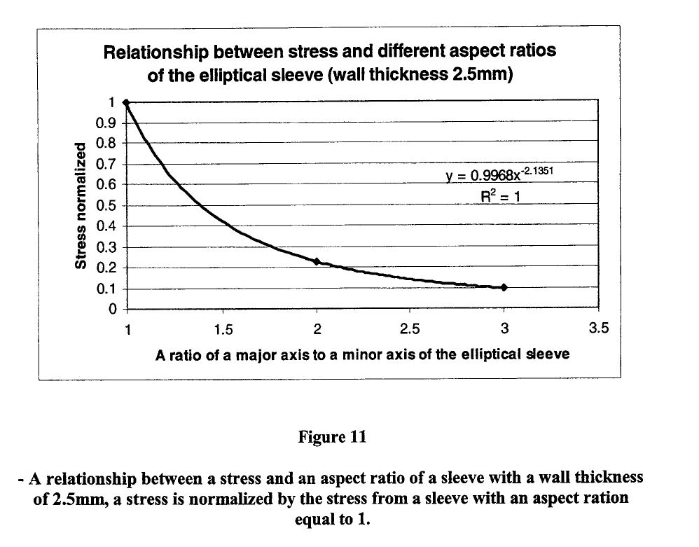

Preferably, the invention relates to a UV fluid treatment system comprising cross-flow radiation source assemblies comprising elliptical sleeves. The elliptical sleeves should be placed in an optimal pattern to have less hydraulic resistance (see FIG. 5 for a preferred embodiment). The radiation sources (preferably UV lamps) should be placed in the cavity of the elliptical sleeve which would prevent wastewater directly acting on the UV lamps. The major axis of the elliptical sleeve preferably is oriented in the same direction as the bulk fluid flow to reduce the bending stress on the sleeve. The optimum ratio of the major axis of the elliptical sleeve to its minor axis (this is also referred to as the aspect ratio—see FIG. 10) may be determined empirically by the stress on the sleeve and disinfection performance, however the ratio usually should be larger than 1—see FIG. 11 which illustrates the relationship between stress (normalized) and aspect ratio (i.e., ratio of major axis to minor axis) of the outer surface of the present radiation source assembly. A particularly preferred orientation of the radiation source assembly (i.e., radiation sources in combination with elliptical sleeve) is described in copending International patent application Ser. No. PCT/CA2007/001989 [Zheng et al.].

With reference to FIG. 10b, there is illustrated a cross-section of an alternate preferred sleeve configuration for the present radiation source assembly. As shown, the sleeve configuration in FIG. 10b is symmetrical along a longitudinal axis that his parallel to the direction of fluid flow (this is the preferred orientation of the sleeve—i.e., the “tail” portion of the sleeve pointing a downstream direction). Further, as shown, the shape of the sleeve has a decreasing width along the longitudinal axis in a direction from the upstream end to the downstream end. Another way of envisioning this embodiment is there is a decreasing gradient of width dimension from an upstream end to a downstream end of the sleeve.

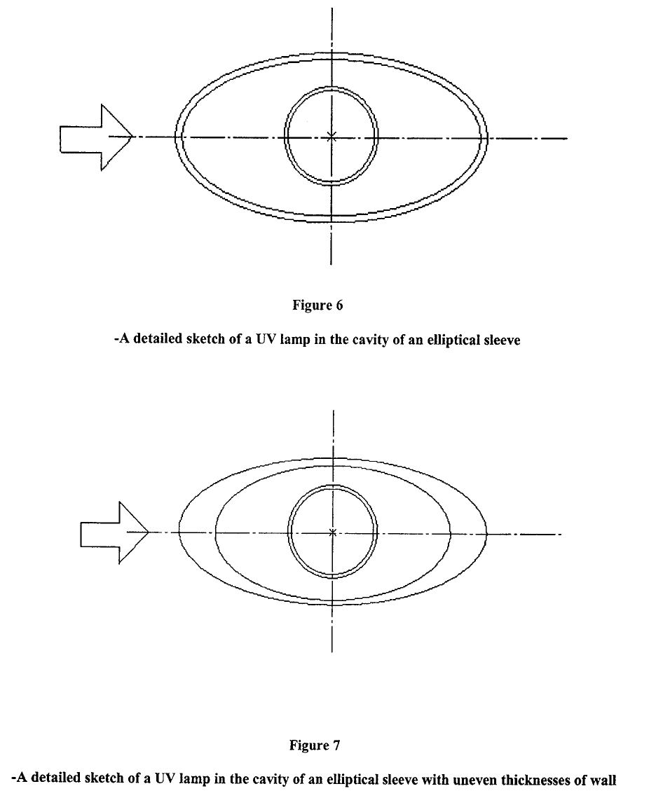

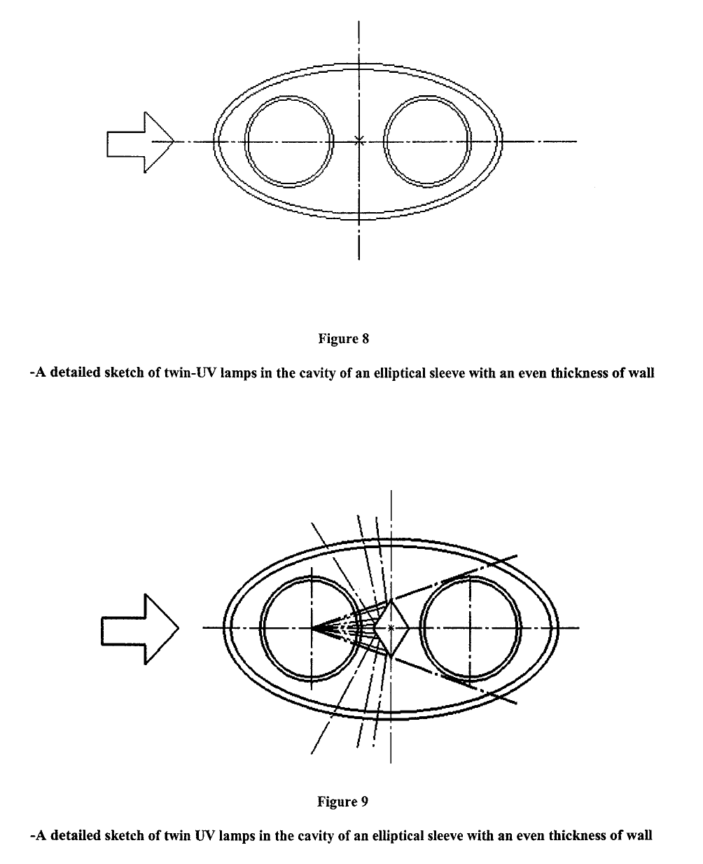

An elliptical sleeve could have a single UV lamp or twin-UV lamps in the cavity of the elliptical sleeve (see FIGS. 6 and 8). Preferably, a single UV lamp is placed in the cavity coaxially with respect to the elliptical sleeve. Preferably, the twin UV lamps are placed in the cavity at an even distance from the center point of the elliptical sleeve.

To maximize UV light emitted from twin UV lamps, a UV reflector could be placed at the center of the elliptical sleeve (see FIG. 9). The UV reflector should be designed in a way that the reflector would produce reflective angles that would optimally reflect a partial UV ray from inside of the elliptical sleeve into the water.

In a preferred embodiment, the sleeve strength of an elliptical sleeve may be increased by incorporation of an uneven thickness in its wall (see FIG. 7). At the front (upstream) and or back (downstream) of the elliptical sleeve the thickness of the sleeve wall would be thicker than at the sides. The sides of the sleeve would be relatively thin. In this way, the sleeve will have an increased resistance to a bending stress and will minimize its transmittance losses of UV light through the quartz sleeve walls. The quartz walls are thicker and stronger at the sleeve ends (upstream and downstream) where there are higher physical material stresses. Further, the quartz walls are relatively thin on the side portions and therefore more UV transparent where there is less physical or material stress and where it is more important to have more UV light (i.e., where there are higher flow velocities).

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. For example, it is possible and, in some cases, preferred to implement the present fluid treatment system with a fluid treatment zone having an open or other non-closed cross-section (e.g., in an open channel system such as is described in the Maarschalkerweerd #1 Patents referred to above). Still further, it is possible and, in some cases, preferred to implement the present fluid treatment system with a fluid treatment zone having a semi-enclosed cross-section (e.g., such as is described in the Maarschalkerweerd #2 Patents referred to above). Still further, it is possible and, in some cases, preferred to implement the present fluid treatment system with a fluid treatment zone that employs so-called “hybrid” radiation source modules (e.g., such as described in International Publication Number WO 2002/048050 [Traubenberg et al.] or in International Publication Number WO 2004/000735 [Traubenberg et al.]). Still further, it is possible to incorporate a mechanical or chemical/mechanical cleaning system to remove fouling materials from the exterior of the radiation source assemblies as described various published patent applications and issued patents of Trojan Technologies. Still further, a variety of conventional sealing systems made of a variety of materials may be used in the present fluid treatment system. The selection of sealing materials and the placement thereof to obtain a sufficient seal is not particularly restricted. Still further, it is possible to modify the illustrated embodiments to use weirs, dams and gates upstream, downstream or both upstream and downstream to optimize fluid flow upstream and downstream of the fluid treatment zone defined in the fluid treatment system of the present invention. Still further, it is possible to modify the illustrated embodiments to provide multiple banks of radiation source assemblies in hydraulic series. Still further, it is possible to modify the illustrated embodiments to utilize a radiation source assembly comprising a plurality of radiation sources disposed in a protective sleeve (i.e., sometimes referred to in the art as a “lamp bundle”). It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A radiation source assembly comprising an elongate radiation emitting outer portion having non-circular cross-sectional shape and an elongate radiation source.

2. The radiation source assembly defined in claim 1, wherein the elongate radiation emitting outer portion and the elongate radiation source are integral.

3. The radiation source assembly defined in claim 1, wherein the elongate radiation emitting outer portion and the elongate radiation source are independent elements.

4. The radiation source assembly defined in claim 3, wherein the elongate radiation emitting outer portion comprises a radiation transparent sleeve element.

5. The radiation source assembly defined in claim 4, wherein the radiation transparent sleeve element and the elongate radiation source are disposed in a substantially coaxial arrangement.

6. The radiation source assembly defined in claim 4, wherein the radiation transparent sleeve element and the elongate radiation source are disposed in a non-coaxial arrangement.

7. The radiation source assembly defined in claim 6, comprising a plurality of elongate radiation sources disposed in a single radiation transparent sleeve element.

8. The radiation source assembly defined in claim 6, comprising two elongate radiation sources disposed in a single radiation transparent sleeve element.

9. The radiation source assembly defined in claim 7, further comprising a radiation reflecting element interposed between a pair of elongate radiation sources.

10. The radiation source assembly defined in claim 4, wherein the radiation transparent sleeve element comprises a pair of open ends.

11. The radiation source assembly defined in claim 10, wherein the elongate radiation source comprises a first electrical connector at one end thereof and a second electrical connect at another end thereof.

12. The radiation source assembly defined in claim 4, wherein the radiation transparent sleeve element comprises a closed end and an open end.

13. The radiation source assembly defined in claim 12, wherein the elongate radiation source comprises a first electrical connector and a second electrical connector at one end thereof.

14. The radiation source assembly defined in claim 1, wherein the elongate radiation emitting outer portion has a cross-sectional shape that comprises a first dimension along a first axis and a second dimension along a second axis, the first dimension being greater than the second dimension.

15. The radiation source assembly defined in claim 14, wherein the first axis is orthogonal to the second axis.

16. The radiation source assembly defined in claim 14, wherein the first axis is an axis of symmetry.

17. The radiation source assembly defined in claim 14, wherein the second axis is an axis of symmetry.

18. The radiation source assembly defined in claim 14, wherein each of the first axis and the second axis is an axis of symmetry.

19. The radiation source assembly defined in claim 14, wherein the elongate radiation emitting outer portion comprises a substantially uniform thickness.

20. The radiation source assembly defined in claim 14, wherein the elongate radiation emitting outer portion comprises a variable thickness.

21. The radiation source assembly defined in claim 20, wherein the variable thickness is in the form of an thickness gradient along a span of the elongate radiation emitting outer portion between the first axis and the second axis.

22. The radiation source assembly defined in claim 20, wherein the variable thickness is in the form of a decreasing thickness gradient along at least a span of the elongate radiation emitting outer portion between the first axis intercept and the second axis intercept.

23. The radiation source assembly defined in claim 20, wherein the variable thickness is in the form of a decreasing thickness gradient along each span of the elongate radiation emitting outer portion between the first axis intercept and the second axis intercept.

24. The radiation source assembly defined in claim 20, wherein the first axis is coterminous with a maximum thickness of the elongate radiation emitting outer portion.

25. The radiation source assembly defined in claim 20, wherein the elongate radiation emitting outer portion comprises a pair of maximum thickness dimensions in alignment with the first axis.

26. The radiation source assembly defined in claim 14, wherein the cross-sectional shape comprises an oval.

27. The radiation source assembly defined in claim 14, wherein the cross-sectional shape comprises an ellipse.

28. The radiation source assembly defined in claim 14, wherein the cross-sectional shape comprises an obround.

29. The radiation source assembly defined in claim 14, wherein the cross-sectional shape comprises a lens.

30. The radiation source assembly defined in claim 1, wherein the radiation source is an ultraviolet radiation source.

31. A radiation source module for use of fluid treatment system, the module comprising:
a frame having a first support member;
at least one radiation source assembly as defined in claim 1 extending from and in engagement with a first support member.

32. The radiation source module defined in claim 31, wherein the frame further comprises a second support member opposed to and laterally spaced from the first support member, the at least one radiation source assembly disposed between each of the first support member and the second support member.

33. The radiation source module defined in claim 32, wherein the frame further comprises a third support member interconnecting the first support member and the second support member.

34. The radiation source module defined in claim 31, wherein the frame further comprises a ballast for controlling the at least one radiation source.

35. The radiation source module defined in claim 31, wherein the first support member comprises a hollow passageway for receiving an electrical connector for conveying electricity to the at least one radiation source.

36. The radiation source module defined in claim 31, comprising a plurality of radiation source assemblies in engagement with a single frame.

37. A fluid treatment system comprising:
a fluid treatment zone;
at least one radiation source assembly as defined in claim 1 disposed in the fluid treatment zone.

38. The fluid treatment system defined in claim 37, wherein the fluid treatment zone comprises a closed chamber through which fluid flows.

39. The fluid treatment system defined in claim 37, wherein the at least one radiation source assembly is secured to closed chamber.

40. The fluid treatment system defined in claim 38, wherein the closed chamber is disposed in an open channel for receiving fluid.

41. The fluid treatment system defined in claim 37, wherein the fluid treatment zone comprises an open channel for receiving fluid.

42. The fluid treatment system defined in claim 37, wherein the at least one radiation source assembly is oriented in manner such that a longitudinal axis thereof is substantially parallel with respect to a direction of fluid flow through the fluid treatment system.

43. The fluid treatment system defined in claim 37, wherein the at least one radiation source assembly is oriented in manner such that a longitudinal axis thereof is transverse with respect to a direction of fluid flow through the fluid treatment system.

44. The fluid treatment system defined in claim 37, wherein the at least one radiation source assembly is oriented in manner such that a longitudinal axis thereof is orthogonal with respect to a direction of fluid flow through the fluid treatment system.

45. The radiation source assembly defined in claim 44, wherein the elongate radiation emitting outer portion of the radiation source assembly has a cross-sectional shape that comprises a first dimension along a first axis and a second dimension along a second axis, the first dimension being greater than the second dimension, the first axis being in substantial alignment with the direction of fluid flow through the fluid treatment system.

46. A fluid treatment system comprising:
a fluid treatment zone;
at least one radiation source module as defined in claim 31 disposed in the fluid treatment zone.

47. The fluid treatment system defined in claim 46, wherein the fluid treatment zone comprises a closed chamber through which fluid flows.

48. The fluid treatment system defined in claim 46, wherein the at least one radiation source assembly is secured to closed chamber.

49. The fluid treatment system defined in claim 47, wherein the closed chamber is disposed in an open channel for receiving fluid.

50. The fluid treatment system defined in claim 46, wherein the fluid treatment zone comprises an open channel for receiving fluid.

51. The fluid treatment system defined in claim 46, wherein the at least one radiation source assembly is oriented in manner such that a longitudinal axis thereof is substantially parallel with respect to a direction of fluid flow through the fluid treatment system.

52. The fluid treatment system defined in claim 46, wherein the at least one radiation source assembly is oriented in manner such that a longitudinal axis thereof is transverse with respect to a direction of fluid flow through the fluid treatment system.

53. The fluid treatment system defined in claim 46, wherein the at least one radiation source assembly is oriented in manner such that a longitudinal axis thereof is orthogonal with respect to a direction of fluid flow through the fluid treatment system.

54. The radiation source assembly defined in claim 53, wherein the elongate radiation emitting outer portion of the radiation source assembly has a cross-sectional shape that comprises a first dimension along a first axis and a second dimension along a second axis, the first dimension being greater than the second dimension, the first axis being in substantial alignment with the direction of fluid flow through the fluid treatment system.
